(19) United States
(12) Patent Application Publication
(10) Pub. No.: US 2005/0129909 A1
(43) Pub. Date: Jun. 16, 2005

(54) Treatment composite for a substrate

(75) Inventors: Harrie Hermens, Heerlen (NL); Mark Van Bommel, Heerlen (NL); Armin Plichta, Sponheim (DE); Thomas Zetterer, Engelstadt (DE)

Correspondence Address: Charles N. J. Ruggiero, Esq.;Ohlandt, Greeley, Ruggiero & Perle, L.L.P., 10th Floor, One Landmark Square, Stamford, CT, 06901-2682, US

(73) Assignee: Schott AG

(21) Appl. No.: 10/966,069

(22) Filed: Oct. 15, 2004

(30) Foreign Application Priority Data
Oct. 18, 2003 (DE) 103 48 946.0

(51) Int. Cl. B32B 3/10

(52) U.S. Cl. 428/138

(57) ABSTRACT

The invention relates to a composite which comprises a substrate, especially an ultra-thin substrate with a thickness of less than 0.3 mm, and a carrier substrate, with the substrate being detachably connected at least indirectly with the carrier substrate. The composite in accordance with the invention is characterized in that a spacer layer with recesses is introduced between substrate and carrier substrate, with the recesses being provided at least in the surface of the spacer layer which faces the substrate.

The present invention relates to a composite which comprises a substrate, especially an ultra-thin substrate, and a carrier substrate. The substrate and carrier substrate are joined with each other in order to thus produce a stable self-supporting structure. Thin substrates relate below especially to substrates made of glass for example or a glass-containing material which has a thickness of less than 0.3 mm.

Currently, glasses of a thickness of 0.3 to 2 mm are used as a standard in the display industry for producing displays. Glass thicknesses of 0.7 mm and 0.5 mm (0.4 mm) are used in particular for displays of mobile phones, PDAs. These glasses are stiff and self-supporting and the equipment for display production is optimized for such thicknesses.

If one wishes to use ultra-thin substrates with thicknesses of below 0.3 mm such as glass or polymer films for digital or analog displays which offer the advantage that they are flexible for example, such ultra-thin substrates can no longer be processed in conventional processes because the substrate surfaces will bend through to a high extent under their own weight, which is generally known as sagging. Moreover, such ultra-thin substrates are very sensitive to excessive mechanical stress. As a result, the glass substrates can be damaged during different process steps, e.g. they can break during the washing process or when being coated in the liquid phase. Further sources for damage are mechanical jamming or impacts. There is also a likelihood that the ultra-thin substrates will get stuck in conventional processes, e.g. during the automatic substrate transport between different production steps. As a result of the bending of the ultra-thin substrates it is also possible that tolerance requirements of processes are breached, .e.g. the flatness requirements of exposure processes, leading to a deterioration in the imaging properties. The exposure processes can be in the field of lithographic processes or mask exposure processes. Moreover, thin flexible substrates tend to produce significant natural oscillations by absorbing or being excited by surrounding ambient and impact sounds.

On the other hand, it is desirable to provide thinner, lighter, bent or flexible displays. This can be achieved by using ultra-thin substrates which have thicknesses of <0.3 mm.

Problems arise however for the reasons stated above for the handling of ultra-thin substrates in conventional installations for the production of displays.

It is known to fasten respective substrates to each other with a carrier substrate into a composite in order to thus obtain a self-supporting structure. The problem remains however that the ultra-thin substrate needs to be removed from the carrier substrate again without damaging the same in order to separate the processed ultra-thin substrates.

Object of the invention is therefore to overcome the disadvantages of the state of the art and to provide a composite which facilitates the handling, processing and transport of substrates, and especially ultra-thin substrates. In particular it should enable the separation without damaging the ultra-thin substrate. Moreover, the operational effort is to be kept as low as possible.

This object is achieved by a composite in accordance with claim 1. The dependent claims describe especially advantageous further developments of the invention.

According to claim 1, the composite in accordance with the invention comprises a substrate, and in particular an ultra-thin substrate, and a carrier substrate. The substrate is joined to the carrier substrate. The connection can be provided directly between substrate and carrier substrate. It is also possible to provide indirect connections. The connection is preferably provided with a detachable configuration.

According to the invention, a spacer layer is introduced between the ultra-thin substrate and the carrier substrate which is provided with recesses. The recesses are provided at least in the surface of the spacer layer which faces the substrate, and in particular the ultra-thin substrate with a thickness of less than 0.3 mm.

By interposing a spacer layer in accordance with the invention between the substrate and the carrier substrate, a deflection or damaging of the substrate is effectively prevented. On the other hand, the purposeful selection of a spacer layer with a predetermined thickness ensures that a desired overall thickness of the composite is set. In particular, a constant overall thickness of the composite can be maintained despite varying thickness of substrates by a respective adjustment of the spacer layer. This is especially advantageous when the composite in accordance with the invention is used in a production process of LCDs, especially in front-end LCD processing, because despite the varying substrate thickness it is here possible to process the substrates in conventional systems which demand a standard thickness. It is understood that it is also possible (and is preferable in the case of a spacer layer that is provided with a very thin configuration) to set the overall thickness of the composite alternatively or additionally by varying the thickness of the carrier substrate.

As a result of the formation of the spacer layer with recesses (at least on the surface of the spacer layer) which face the substrate, it is possible that the substrate can be separated especially easily after processing from the carrier substrate because the adhesive forces of attraction of the ultra-thin substrate and the carrier substrate, e.g. Van der Waals forces, are low when using a spacer layer with recesses. In contrast to this, in the case of composites made of an ultra-thin substrate and a carrier substrate where the spacer layers are provided without any recesses, the substrates (and in particular the ultra-thin substrates) tend to break through when lifted off or to deform in an impermissible way because the adhesive powers between substrate and spacer layer are very high.

The use of the composite in accordance with the invention is not limited to LCD production. The composite in accordance with the invention can also be used in the following fields for example:
in the display industry
for producing optoelectronic components
in optoelectronics
in polymer electronics
in photo-voltaic technology
in sensor technology
in biotechnology
in medicine (medical applications)

An embodiment of a composite which is very easy to produce comprises recesses in the spacer layer which are configured as pass-through openings, which means that the recesses extend from a first surface of the spacer layer up to a second surface of the spacer layer. The first surface of the spacer layer is the surface which faces the substrate and the second surface is the one facing the carrier substrate. When configuring the recesses as pass-through openings, the adhesive powers are overcome especially easily when lifting the substrate from the carrier substrate after processing or transport.

A spacer layer with pass-through openings can be achieved for example in such a way that the spacer layer is formed from a plurality of spacer elements which are arranged at a distance from each other. When referring to the distance with respect to each other, this shall mean the distance in one plane which is equiplanar relative to the substrate plane.

The spacer layer can be configured as a grid structure or as a planar layer with a plurality of pass-through bores. It is understood that any desired mixed forms are possible.

A plurality of rods which are arranged in parallel and at a distance from each other has proven to be especially advantageous. The rods can have a circular, oval, rectangular or square cross section. The spacer layer can also be arranged from a plurality of mutually spaced balls which are connected with each other especially by spacer rods.

The adhesive power to be overcome when lifting off the substrate from the spacer layer can be set by the ratio of the total surface area of the recesses to the total surface area of the surface of the spacer layer facing the ultra-thin substrate.

In one embodiment, the pass-through openings of the spacer layer have an even cross section, starting from the surface facing the substrate up to the surface facing the carrier substrate. The respective cross section can also be provided with a conical configuration. It is possible that the cross section expands in a conical way in the mentioned direction, namely starting out from the surface of the spacer layer facing the substrate. This allows on the one hand a bearing surface of the substrate (and especially the ultra-thin substrate) having a relatively large expansion in order to prevent deflection. On the other hand, the adhesive powers for lifting the substrate are relatively low because air can flow through the conically expanded cross sections.

The spacer layer can advantageously be made of plastic material or a polymer or a material which contains plastic or polymer.

The carrier substrate is preferably made of glass or a glass-containing material.

The composite has an overall thickness of 0.4 mm to 1.1 mm for example. It is especially advantageous when the composite has a total thickness of 0.5 mm because this corresponds to the mentioned standard thickness of conventional LCD production lines.

The spacer layer of the composite in accordance with the invention is advantageously configured as an exchangeable part with varying thickness that in the case of varying substrate thickness the overall thickness of the composite remains unchanged by a respective choice of the spacer layer.

One possibility for joining the individual layers of the composite in accordance with the invention is to join the substrate (and in particular the ultra-thin substrate) in a detachable way with the spacer layer and to join the spacer layer in a detachable way with the carrier substrate. The spacer layer can alternatively also be joined in a non-detachable way with the carrier substrate. In this case the spacer layer in combination with the carrier substrate represent the respective exchangeable part for setting an unchanged overall thickness of the composite.

In a further embodiment or in addition it is possible to detachably join the substrate (and in particular the ultra-thin substrate) directly with the carrier substrate.

The configuration of the composite in accordance with the invention allows joining a substrate indirectly or directly with a carrier substrate, with the spacer layer being interposed. Thereafter the substrate (and in particular the ultra-thin substrate) can be processed and/or treated and/or transported. After the completion of the processing/treatment or transport, the substrate can be detached from the carrier substrate again, with the configuration of the spacer layer with the recesses in accordance with the invention ensuring that—as is shown—the adhesive powers are low.

Gluing or thermal joining methods can be used for joining. The substrate can be molten on the carrier substrate for example. One possibility is dosing a thin strip of adhesive on the edge of a carrier substrate (or the ultra-thin substrate), to apply the spacer layer and finally to bring the ultra-thin substrate (or the carrier substrate) into contact in such a way that the circular gluing produces a connection between the ultra-thin substrate and the carrier substrate. Alternatively, the circular adhesive layer can also be produced by an immersion method either on the edge of the carrier substrate or the ultra-thin substrate. Suitable adhesives are in these cases simple adhesives that cure at room temperature or adhesives that cure in a thermal manner at higher temperatures (typically 200° C. to 600° C.), UV-hardening adhesives or glass solders for example.

A further joining method is to melt the ultra-thin substrate on the carrier substrate by means of laser radiation for example and to join the two by means of the achieved melt. If the locally occurring melting process is supplemented by a respective controllable optical system or mechanism, it is also possible to produce circular connection seams in this case too, which seams lead to a respective joining between the ultra-thin substrate and the carrier substrate.

Conventional LCD separation technology can be used for separation after the processing. Especially when the carrier substrate is made of glass, the same can thus be removed from the ultra-thin substrate, such that it is notched at first and is then broken by bending along the notch.

The composite in accordance with the invention allows processing substrates with varying thickness in conventional installations, especially for the production of LCDs. By a respective choice of the thickness of the spacer layer and/or the carrier substrate, standard thicknesses of the composite can be achieved very easily. A conversion of the production lines to different thicknesses is not necessary. The composite can be used in virtually all production lines of a display production (especially in passive matrix (PM) and active matrix (AM) LCD production installations) which are configured for the dimensions (format and thickness) of the composite.

An especially advantageous embodiment of the spacer layer is achieved in such a way that small balls with a diameter corresponding to the desired distance (e.g. with a diameter of 6 μm which correspond in particular to the spacer balls used in the LCD industry) are sprinkled as spacers onto the carrier substrate or the (ultra-thin) substrate. These balls may consist of any desirable material as long as the optical and other properties of the substrate are not influenced negatively. Especially suitable are balls made of glass or polymer or a glass- or polymer-containing material. Finally, the (ultra-thin) substrate and the carrier substrate can be joined together. An adjustment of the overall thickness of the composite with a spacer layer made of sprinkled balls is advantageously produced by setting the thickness of the carrier substrate.

The invention is now explained in closer detail by reference to a number of embodiments shown in the drawings. The embodiments are only exemplary and do not limit the scope of protection. The figures show:

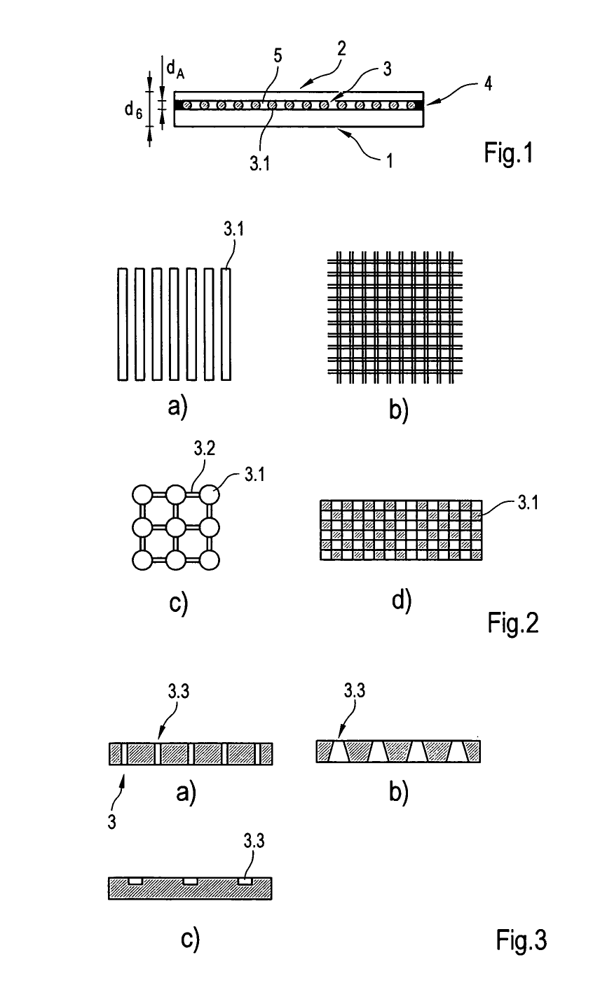

FIG. 1 shows a cross-sectional view through a composite configured in accordance with the invention;

FIG. 2 shows a top view of different embodiments of a spacer layer for a composite in accordance with the invention;

FIG. 3 shows different embodiments of a cross section through a spacer layer of a composite in accordance with the invention;

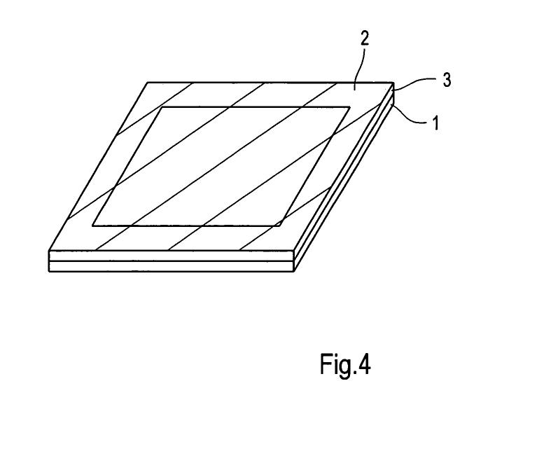

FIG. 4 shows a composite with a spacer layer configured as a frame.

FIG. 1 shows a carrier substrate 1 to which an ultra-thin substrate 2 is joined. The ultra-thin substrate has a thickness which is considerably lower than that of the carrier substrate. The ultra-thin substrate can be a flexible substrate for the production of LCD displays. A spacer layer 3 is provided in accordance with the invention between the ultra-thin substrate and the carrier substrate. The spacer layer 3 consists of individual spacer elements 3.1 which are configured relative to each other with a space such that intermediate spaces 5 remain between the individual spacer elements 3.1 which on lifting the ultra-thin substrate 2 from the carrier substrate 1 will reduce the adhesive powers.

At the same time, the overall thickness d_{G} is set to a constant dimension by the thickness d_{A} of the individual spacer elements 3.1 or the carrier substrate or even the spacer layer. If the spacer layer is provided with a very low thickness (e.g. in the region of a number of micrometers (μm)), it is advantageous to set the overall thickness by respectively setting the thickness of the carrier substrate.

The ultra-thin substrate 2 and the carrier substrate 1 are mutually sealed by means of a sealing element 4 in the region of their outer circumference. FIG. 2 shows top views of different embodiments of the spacer layer 3.

In FIG. 2a, the spacer layer 3 is arranged from a plurality of rod-like elements which are arranged at a distance from each other and parallel relative to each other. They can be additionally joined to each other by means of transversal beams or spacer elements. An outer frame for joining the individual elements is also possible. Both measures are not shown however. The spacer element of FIG. 2b is shown in the form of a grid.

FIG. 2c shows spacer elements 3.1 which are spherical and are connected with each other through spacer elements 3.2.

In FIG. 2d, the illustrated spacer layer consists of a plurality of spacer elements 3.1 which are arranged in a discontinuous pattern, so that the recesses in the middle region of the spacer element are larger than in the boundary region.

FIG. 3a shows a cross-sectional view of a spacer layer 3 with cylindrical recesses 3.3. FIG. 3b shows a spacer layer 3 with recesses 3.3 which expand conically from the side of the ultra-thin substrate to the side of the carrier substrate. FIG. 3c shows a cross-sectional view through a spacer layer in which recesses 3.3 are only provided on the side facing the ultra-thin substrate.

FIG. 4 shows a composite with an ultra-thin substrate 2 which has a thickness of less than 0.3 mm and which is applied to a frame-like carrier substrate 1. A spacer layer 3 is introduced between the carrier-like frame substrate which forms a rectangular frame and in particular a square frame and the ultra-thin substrate 2. The spacer layer 3 is also frame-like, meaning that it encloses a spacer-layer-free space below the ultra-thin substrate 2.

The spacer layer 3 can simultaneously exercise a sealing means function, i.e. it seals the ultra-thin substrate 3 relative to the carrier substrate 1 along the outer circumference. One could also designate spacer layer 3 as a frame-like sealing element.

In order to achieve an especially favorable hold of the ultra-thin substrate 2 on the frame-like carrier substrate 1, the ultra-thin substrate is fixed especially in a point-like way to the carrier substrate. The point-like fixing can be produced especially by riveting, soldering or spot welding. It is understood that detachable joining techniques can also be used.

Departing from the previous embodiments in which the spacer layer 3 is introduced substantially over the entire planar surface between the substrate and the carrier substrate and comprises a plurality of openings which are arranged distributed over the entire bearing surface of the substrate on the carrier substrate, the spacer layer 3 in accordance with FIG. 4 merely comprises one single rectangular opening. Although in the edge region there is also provided a planar placement of the ultra-thin substrate 2 on the spacer layer 3, the same does not extend over the entire lower side of the substrate, as is provided alternatively in the other embodiments.

Departing from the description above, it is possible in the embodiment in accordance with FIG. 4 to provide only the spacer layer 3 with a frame-like configuration and to provide the carrier substrate 1 with a full planar surface, i.e. with a rectangular cross section for example. A hollow space is thus enclosed by the frame-like spacer layer 3 between the all-over ultra-thin substrate 2 and the all-over carrier substrate 1.

Finally, a number of advantages of the composite in accordance with the invention will be summarized again:
Standard LCD production methods and devices can be used for the production or processing of substrates, and in particular ultra-thin substrates, with an overall thickness being achieved by using a composite with a relatively thick carrier substrate which is comparable with conventionally used glass thicknesses in LCD production. In this process it is possible to use carrier substrates, ultra-thin substrates and spacer layers with different thicknesses in order to adjust the overall thickness of the composite for example.
Sagging is reduced considerably in comparison with the sole use of ultra-thin glasses.
The fracture risk is also reduced considerably when the edge of the ultra-thin substrate is retracted slightly relative to the edge of the carrier substrate, e.g. with an offset of 1 mm for example.
Standard LCD separation methods can be used for the separation of the substrate from the carrier substrate, and
the adhesive powers can be overcome more easily when separating substrate and carrier substrate.

When separating a composite between two (glass) surfaces, forces also can or need to be overcome which are not based on Van der Waals forces. For example, it may occur in some process steps (especially in vacuum processes in which the water film is removed and/or at higher temperatures) that chemical bonds originate between the surfaces (Si—O—Si for example in addition to hydrogen bridge bonds) which need to be dissolved again. Such a solution is also facilitated by the configuration of the composite in accordance with the invention.

It should be understood by a person skilled in the art, that the disclosure content of this application comprises all possible combinations of any element(s) of any claims with any element(s) of any other claim, as well as combinations of all claims amongst each other.

1. A composite, comprising:
an ultra-thin substrate with a thickness of less than 0.3 mm;
a carrier substrate, the ultra-thin substrate being connected at least indirectly with the carrier substrate; and
a spacer layer with recesses between the ultra-thin substrate and the carrier substrate, the recesses being provided at least in a first surface of the spacer layer that faces the ultra-thin substrate.

2. The composite in accordance with claim 1, wherein the recesses are provided as pass-through openings that penetrate the spacer layer from the first surface to a second surface that faces the carrier substrate.

3. The composite in accordance with claim 1, wherein the spacer layer is a plurality of spacer elements arranged relative to each other with a regular or irregular distance.

4. The composite in accordance with claim 1, wherein the spacer layer is a grid structure.

5. The composite in accordance with claim 1, wherein the spacer layer is a plurality of rods that are arranged at a distance from each other and parallel with respect to each other.

6. The composite in accordance with claim 5, wherein the plurality of rods have a cross section selected from the group consisting of circular, oval, rectangular, and square.

7. The composite in accordance with claim 3, wherein the plurality of spacer elements are individual balls that are joined with each other by spacer rods.

8. The composite in accordance with claim 1, wherein the first surface has a ratio of space left open to the overall surface of the spacer layer between 0.1 and 0.9999.

9. The composite in accordance with claim 2, wherein the recesses have an even cross section.

10. The composite in accordance with claim 2, wherein the recesses have a conical cross section.

11. The composite in accordance with claim 10, wherein the conical cross section is conically expanded from the first surface to the second surface.

12. The composite in accordance with claim 1, wherein the spacer layer comprises a material selected from the group consisting of plastic, polymer, and glass.

13. The composite in accordance with claim 1, wherein the composite has a total thickness of 0.4 mm to 1.1 mm.

14. The composite in accordance with claim 1, wherein the spacer layer and/or the carrier substrate is/are configured as an exchangeable part with a thickness so that a total thickness of the composite always has a predetermined constant dimension.

15. The composite in accordance with claim 1, wherein the ultra-thin substrate is detachably connected with the spacer layer and the spacer layer is detachably connected with the carrier substrate.

16. The composite in accordance with claim 1, wherein the ultra-thin substrate is detachably connected with the spacer layer and the spacer layer is not connected with the carrier substrate so that the spacer layer and the carrier substrate form exchangeable parts.

17. The composite in accordance with claim 1, wherein the ultra-thin substrate is directly detachably connected with the carrier substrate.

18. The composite in accordance with claim 1, wherein the carrier substrate is made of glass or a glass-containing material.

19. The composite in accordance with claim 1, wherein the ultra-thin substrate and the carrier substrate are mutually joined in the region of their outer circumference.

20. The composite in accordance with claim 1, wherein the spacer layer and the carrier substrate (1) are provided with a frame-like configuration and enclose a space.

21. The composite in accordance with claim 20, wherein the spacer layer forms a sealing element between the ultra-thin substrate and the carrier substrate.

22. The composite in accordance with claim 20, wherein the ultra-thin substrate and the carrier substrate are fixed to one another in points.

23. A method for treating an ultra-thin substrate with a thickness of less than 0.3 mm, comprising:
detachably connecting the ultra-thin substrate in an at least indirect way with a carrier substrate
introducing a spacer layer between the ultra-thin substrate and the carrier substrate so that a composite is obtained;
treating the composite; and
detaching the ultra-thin substrate from the carrier substrate after the completion of the treatment.

24. The method according to claim 23, wherein detachably connecting the ultra-thin substrate with the carrier substrate comprises gluing and/or melting.

25. The method according to claim 23, wherein detaching the ultra-thin substrate from the carrier substrate comprises breaking the carrier substrate.

26. The method according to claim 23, wherein detaching the ultra-thin substrate from the carrier substrate comprises notching and breaking the ultra-thin substrate.

27. A composite in accordance with claim 8, wherein the ratio is 0.99.

28. A composite in accordance with claim 1, wherein the total thickness is 0.5 mm.

29. A method according to claim 25, wherein breaking the carrier substrate comprises notching the surface of and bending the carrier substrate.
